(19) United States
(12) Patent Application Publication
(10) Pub. No.: US 2011/0166382 A1
(43) Pub. Date: Jul. 7, 2011

(54) PROCESSES FOR OBTAINING A PHOSPHONIC ACID FROM A PHOSPHONIC ACID ANHYDRIDE

(75) Inventors: Graham Robert Cumming, Cleveland (GB); Geoffrey Fuller, Cardigan (GB)

(73) Assignee: CELTIC CATALYSTS LIMITED

(21) Appl. No.: 12/996,816

(22) PCT Filed: Jun. 8, 2009
(86) PCT No.: PCT/GB09/01440

§ 371 Date: Mar. 1, 2011

(30) Foreign Application Priority Data
Jun. 9, 2008 (GB) 0810529.8
Nov. 13, 2008 (GB) 0820816.7

(51) Int. Cl. C07F 9/6571; C07F 9/28

(52) U.S. Cl. 562/19; 562/8

(57) ABSTRACT

The present invention relates to a process for recovering a phosphonic acid. The present invention also relates to the conversion of a phosphonic acid to a phosphonic acid anhydride.

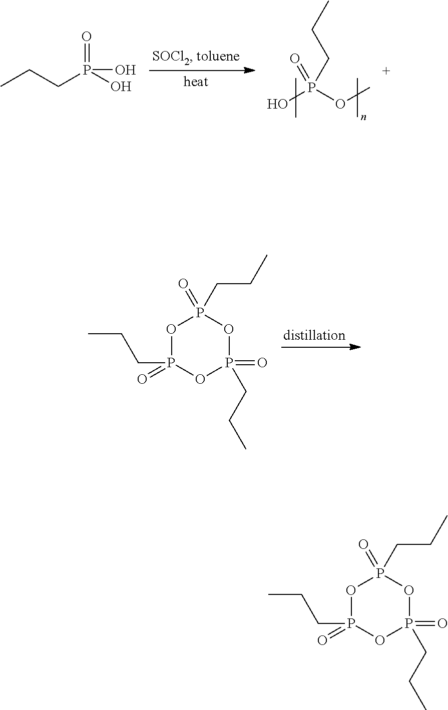

The present invention relates to a process for recycling a phosphonic acid. The present invention also relates to the conversion of a phosphonic acid to a phosphonic acid anhydride.

Phosphonic acid anhydrides, in particular, T3P® (propanephosphonic acid anhydride), are effective coupling and dehydrating agents, and are used primarily as peptide-coupling promoters (Wissman, H.; Kleiner, H. Angew. Chem. Int. Ed. Engl. 1980, 19, 133-134). T3P® alone is used in around 500 tonnes/year. Recently, there has been a large expansion in the type and number of processes that use phosphonic acid anhydrides, especially, alkyl phosphonic acid anhydrides. However, synthesising the carbon-phosphorus bond in an economical fashion is difficult and provides a bar to the degree of production of alkyl phosphonic acid anhydrides. Therefore, there is a need to provide improved processes for synthesising phosphonic acid anhydrides, in particular alkyl phosphonic acid anhydrides.

US 2006/0264654 discloses a process for preparing cyclic phosphonic acid anhydrides from phosphonic acids. If the desired product is a cyclic alkyl phosphonic acid anhydride, however, there is no disclosure of a solution to the problem of synthesising the carbon-phosphorus bond, i.e. it must still be synthesised to produce the starting alkyl phosphonic acid. U.S. Pat. No. 6,420,598 describes a carbon-phosphorus bond-forming process to synthesise the alkyl phosphonic acid, but requires the use of toxic, potentially explosive materials and specialised apparatus.

Typically, phosphonic acid anhydrides are used in coupling reactions and once the reaction is complete and the desired product has been extracted, the waste products, including the spent phosphonic acid anhydrides, are discarded (see, for example, U.S. Pat. No. 5,191,065). This is ecologically problematic as these are degraded by microorganisms, generally to phosphates that are involved in eutrophication.

The present invention overcomes the above-mentioned problems by recycling a spent phosphonic acid anhydride to produce a phosphonic acid, which can then be converted back to a phosphonic acid anhydride. The present invention discloses the surprising finding that the phosphonic components of a solution of spent phosphonic acid anhydride, previously discarded, may be recovered, purified and broken down to a phosphonic acid. Prior to the present invention, there was no known way of converting a useless solution of spent phosphonic acid anhydride to useful phosphonic acid.

Accordingly, the present invention provides a process for the recovery of a phosphonic acid from a solution of a spent phosphonic acid anhydride, comprising the step of:
i) hydrolysis of the solution of spent phosphonic acid anhydride at a sufficient temperature to form the phosphonic acid.

A preferred embodiment of the present invention is a process for the recovery of a phosphonic acid from a solution of a spent phosphonic acid anhydride comprising the steps of:
i) hydrolysis of the solution of spent phosphonic acid anhydride at a sufficient temperature to form the phosphonic acid; and
ii) recovering the phosphonic acid.

A preferred embodiment of the present invention is a process for the recovery of a phosphonic acid anhydride from a solution of a spent phosphonic acid anhydride comprising the steps of:
i) hydrolysis of the solution of spent phosphonic acid anhydride at a sufficient temperature to form the phosphonic acid;
ii) recovering the phosphonic acid; and
iii) converting the phosphonic acid to a phosphonic acid anhydride.

A preferred embodiment of the present invention is a process for the recovery of a phosphonic acid from a solution of a spent phosphonic acid anhydride comprising the steps of
a) salt formation (optional);
i) hydrolysis of the solution of spent phosphonic acid anhydride at a sufficient temperature to form the phosphonic acid; and
ii) recovering the phosphonic acid.

A preferred embodiment of the present invention is a process for the recovery of a phosphonic acid from a solution of a spent phosphonic acid anhydride comprising the steps of:
1) organic residue extraction (optional);
a) salt formation (optional);
b) organic phase extraction (optional);
i) hydrolysis of the solution of spent phosphonic acid anhydride at a sufficient temperature to form the phosphonic acid; and
ii) recovering the phosphonic acid.

A preferred embodiment of the present invention is a process for the recovery of a phosphonic acid anhydride from a solution of a spent phosphonic acid anhydride comprising the steps of:
1) organic residue extraction (optional);
a) salt formation (optional);
b) organic phase extraction (optional);
i) hydrolysis of the solution of spent phosphonic acid anhydride at a sufficient temperature to form the phosphonic acid;
ii) recovering the phosphonic acid; and
iii) converting the phosphonic acid into a phosphonic acid anhydride.

A preferred embodiment of the present invention is a process for the recovery of a phosphonic acid anhydride from a solution of a spent phosphonic acid anhydride comprising the steps of:
1) organic residue extraction;
a) salt formation;
b) organic phase extraction;
i) hydrolysis of the solution of spent phosphonic acid anhydride at a sufficient temperature to form the phosphonic acid;
ii) recovering the phosphonic acid; and
iii) converting the phosphonic acid into a phosphonic acid anhydride.

Further embodiments of the present invention include the phosphonic acid produced by the process of the present invention and the use thereof to produce phosphonic acid anhydrides.

The present invention provides a method for converting a phosphonic acid to a phosphonic acid anhydride wherein SOCl₂ may be used.

The phosphonic acid recovered by the present invention preferably has the following structure:

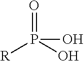

wherein R is an optionally substituted, optionally unsaturated C₁₋₁₀ linear or branched alkyl group, preferably a C₁₋₅ alkyl group (e.g. a methyl, ethyl, propyl, butyl or pentyl group), more preferably a propyl group.

By “optionally substituted” it is meant that one or more optional substituents are present. The one or more optional substituents may be independently selected from the group consisting of F, Cl, a C₄₋₂₀ aryl group, preferably a C₄₋₈ aryl group (e.g. a phenyl group or a benzyl group), a C₁₋₂₀ carboxy, preferably a C₁₋₈ carboxy group, a C₁₋₂₀ alkoxy group, preferably a C₁₋₈ alkoxy group (e.g. a methoxy group or an ethoxy group) or a C₁₋₂₀ ester group, preferably a C₁₋₈ ester group.

By “optionally unsaturated” it is meant that optionally at least one double or triple carbon-carbon bond may be present in the alkyl chain, for example, between 1 and 5 or between 1 and 3 double bonds may be present, for example, 1 double bond.

The starting material of the process of the present invention may be derived from any reaction where a phosphonic acid anhydride is utilised in some form and a solution of a spent phosphonic, acid anhydride is produced. The person skilled in the art would be fully aware of the meaning of the term “spent” in this regard.

For example, the phosphonic acid anhydride may be used as a coupling promoter, a water scavenger or in oxidation processes. Specific examples of coupling reactions in which phosphonic acid anhydride may be used include peptide coupling, conversion of esters to N-protected anilines via hydroxamic acids, in-situ generation of isonitriles, formation of beta-lactams, ester formation, formation of anilides using free acids and formation of amino acid esters.

The spent solution is a mixture of numerous by-products, residual reactants and solvents and wastes that are produced during the reaction involving the phosphonic acid anhydride. There have been no previous successful attempts to rationalise a solution of spent phosphonic acid anhydride. This can be attributed to the highly complex and impure nature of the spent solution. Hence, rationalisation of the spent solution is in no way straightforward; an in-depth knowledge of the chemistry of phosphorus and the convoluted chemical transformations that are occurring is required. Even with this knowledge, the analysis of the various reactions at each step in order to ascertain what phosphonic species are present is highly involved. Armed with phosphorus NMR data for each step in the reaction, rationalisation is still complicated. Given the above facts, there is no reason to believe that a person skilled in the art would look to rationalising the content of a solution of spent phosphonic acid anhydride, let alone actually successfully manage it.

The spent solution comprises phosphonic components that are derived from phosphonic acid anhydride during the course of the reaction in which the phosphonic acid anhydride is utilised. The spent solution may also comprise residual unreacted phosphonic acid anhydride.

The solution of spent phosphonic acid anhydride may be an aqueous or non-aqueous solution, preferably an aqueous solution. The main phosphonic components that are derived from the phosphonic acid anhydride may be phosphonic acid oligomers, which may be in the form of salts, free acids or alkyl esters. The phosphonic acid oligomers may comprise 1 to 20 monomeric units, more preferably 1 to 10, yet more preferably 1 to 5 monomeric units. Preferably the spent solution comprises monomers, dimers, trimers etc and salts thereof, preferably, primarily the linear trimer. Yet more preferably, greater than about 80 wt. % of the phosphonic acid oligomer content is comprised of anionic salts of the linear trimer. In an embodiment of the present invention, the linear trimer may have the structure below:

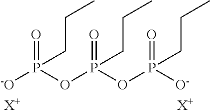

wherein X is an organic or inorganic cation.

Also present in the spent solution may be any residual components from the initial reaction. For example, residual product (the majority of the product has generally been extracted) and derivatives thereof, residual starting materials and derivatives thereof, residual by-products, residual solvents and any other component added to the initial reaction mixture. However, preferably, the major components of the spent solution are phosphonic components.

Preferably, the solution of spent phosphonic acid anhydride is derived from a phosphonic acid anhydride preferably having at least one (i.e. a combination of the cyclic and linear structures may be present) of the following structures:

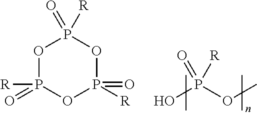

wherein each R is independently an optionally substituted, optionally unsaturated C₁₋₁₀ linear or branched alkyl group, preferably a C₁₋₅ alkyl group (e.g. a methyl, ethyl, propyl, butyl or pentyl group), more preferably a propyl group, and n is an integer between 1 and 300, preferably between about 3 and about 100, more preferably between about 3 and about 20. Preferably, each R group is identical. Preferably, the phosphonic acid anhydride is cyclic. More preferably, the phosphonic acid anhydride is a mixture of cyclic phosphonic acid anhydride and a linear propane phosphonic acid anhydride. For example, the mixture may comprise less than or equal to about 75 wt. % of the total phosphonic acid anhydride content of the cyclic phosphonic acid anhydride, preferably between about 75 wt. % to about 40 wt. %. More preferably, the phosphonic acid anhydride is a mixture of cyclic propane phosphonic acid anhydride and a linear propane phosphonic acid anhydride. Most preferably, the starting material is a solution of spent T3P®.

The hydrolysis in step i) may be carried out by any suitable method known in the art. For example, step i) may comprise the addition of an acid or a base to the solution of spent phosphonic acid anhydride.

When step i) comprises the addition of an acid, the pH of the reaction mixture is preferably adjusted to less than or equal to about 2, preferably about 2 to about 0, more preferably about 1 to about 0, most preferably to about 0. This may be done by any suitable method known in the art. For example, the acid used may be an inorganic acid, preferably, HCl, nitric acid or sulphuric acid. Most preferably, acidification is achieved using conc. HCl.

When step i) comprises the addition of a base, the pH of the reaction mixture is preferably adjusted to equal to or greater than about 10, preferably about 10 to about 14, more preferably about 13 to about 14. This may be done by any suitable method known in the art. For example alkali metal hydroxides, alkaline earth hydroxides, alkali metal carbonates, alkaline earth carbonates, alkali metal bicarbonates and alkaline earth bicarbonates may be used. Preferably, alkali metal hydroxides may be used, for example, NaOH and KOH, most preferably NaOH may be used.

The hydrolysis must be carried out a sufficient temperature to form the phosphonic acid. Step i) may preferably be carried out at a temperature of about 20° C. to about 150° C., preferably about 30° C. to about 120° C., more preferably about 50° C. to about 100° C. Preferably, step i) may be carried out over a period of about 1 hour to about 24 hours, preferably about 1 hour to about 16 hours, more preferably about 1 hour to about 6 hours.

Prior to step i) an optional salt formation step may be carried out (step a)). This may be necessary to ensure that all phosphonic components and related species are present in a suitable salt form and to facilitate the removal of any species that may prejudice the purity of the phosphonic acid product. The pH may be adjusted to equal to or greater than about 10, preferably about 10 to about 14, more preferably about 13 to about 14. This may be done by any suitable method known in the art. For example alkali metal hydroxides, alkaline earth hydroxides, alkali metal carbonates, alkaline earth carbonates, alkali metal bicarbonates and alkaline earth bicarbonates may be used. Preferably, alkali metal hydroxides may be used, for example, NaOH and KOH, most preferably NaOH may be used.

The basified mixture may be stirred for a period of about 30 minutes to about 24 hours, preferably about 1 hour to about 16 hours, more preferably about 1 hour to about 6 hours.

Step a) may produce an organic phase that may comprise organic species present in the initial solution of spent phosphonic acid anhydride. This organic phase is extracted (step b)). The separation of the aqueous and organic phases may be carried out by any suitable method known in the art. The organic phase extracted is discarded or recycled. The product of step a), i.e. the aqueous phase, may be washed with an organic solvent, e.g. methyl tertiary butyl ether (MTBE), to remove any residual organic-soluble impurities.

In an embodiment of the present invention, if step i) is a base hydrolysis, sufficient base may be added in step a) such that it is not necessary to add further base in step i), i.e. the base added for the salt formation may also be used in the hydrolysis reaction.

Prior to step i) or step a), if present, an organic residue extraction step may be carried out (step 1)). This may be necessary to remove any excess organic solvent or organic components from the initial process that remain in the spent solution. This may be done by any method known in the art, for example, ether extraction.

There is no limitation on the solvent used in the reaction that produces the starting material for the process of the present invention. However, for example, solvents such as ethyl acetate, dimethylacetamide, dimethylformamide, dimethyl sulfoxide, phosphoric tris(dimethylamide), N-methyl-pyrrolidone, chloroform, methylene chloride, pyridine, or water or combinations thereof may be used.

The process of the present invention may further comprise a step ii) of recovering the phosphonic acid from the reaction mixture. Step ii) may be carried out by any suitable recovery process known in the art. Step ii) may comprise at least one concentration step where the concentration of the phosphonic acid is increased. Step ii) may also comprise a water removal step. This may involve the use of solvents such as toluene, chloroform, tetrahydrofuran, methyl-tetrahydrofuran or the like that form azeotropes with water. Preferably, a toluene azeotrope is used to remove the water. Step ii) may also comprise a filtration step. The preferred embodiments of step ii) may be carried out by any suitable processes known in the art. A preferred embodiment of step ii) comprises a concentration step, a water removal step, a filtration step and an optional further concentration step, preferably in that order.

An embodiment of the present invention is set forth in the scheme below (the pictographic representation of the coupling wastes is schematic, i.e. it is an indication of the main component of the coupling wastes rather than an exact representation of the coupling wastes as a whole):

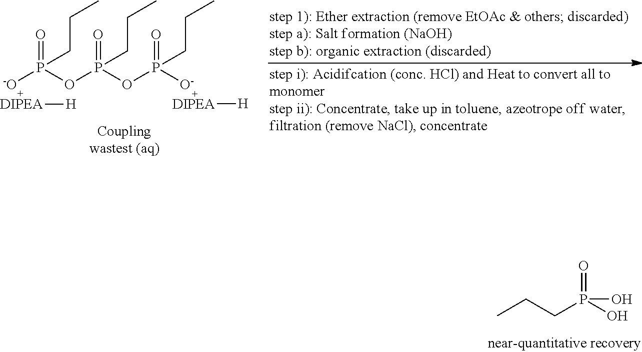

The present invention allows near quantitative conversion of the phosphonic acid derivatives in the waste aqueous phase in to phosphonic acid. For example, greater than 50 wt. %, preferably greater than 70 wt. %, more preferably greater than 80 wt. %.

The starting materials for the process of the present invention preferably may be the waste aqueous phase of any peptide coupling reaction where a phosphonic acid anhydride is used as a coupling promoter (see, for example, Angew. Chem. Int. Ed. 19. 133 (1980) and U.S. Pat. No. 5,191,065).

The peptide coupling reaction is preferably carried out in solvents such as ethyl acetate, dimethylacetaminde, dimethylformamide, dimethyl sulfoxide, phosphoric tris(dimethylamide), N-methyl-pyrrolidone, chloroform, methylene chloride or water or combinations thereof.

Preferably, a base is also present in the peptide coupling reaction mixture. Preferably, the base is a cyclic, linear or branched C₁₋₂₀ alkylamine, more preferably a tertiary alkylamine, for example, triethylamine (TEA) or diisopropylethylamine (DIPEA). The base is preferably present in excess to the phosphonic acid anhydride, for example, at least about 3 molar equivalents, preferably about 3 to about 10, more preferably about 5 to 7. Preferably, the base is an alkylamine and the solvent is an alkyl ester, preferably diisopropylethylamine and ethyl acetate respectively.

The resultant peptide is extracted in an organic phase leaving a waste aqueous phase.

The waste aqueous phase largely consists of salts of phosphonic acid oligomers (for example, monomers, dimers, trimers etc) and salts thereof, primarily the linear trimer and salts thereof. Small quantities of the starting amino acids and derivatives thereof may also be present, as well as any co-acids or co-bases or derivatives thereof present in the starting materials. The waste aqueous phase may also contain residual solvents and bases from the peptide coupling reaction, for example, an alkylamine, preferably diisopropylethylamine, and/or ethyl acetate.

An example of a peptide coupling reaction is set forth in the scheme below (the pictographic representation of the aqueous phase is schematic, i.e. it is an indication of the main component of the aqueous phase rather than an exact representation of the aqueous phase as a whole):

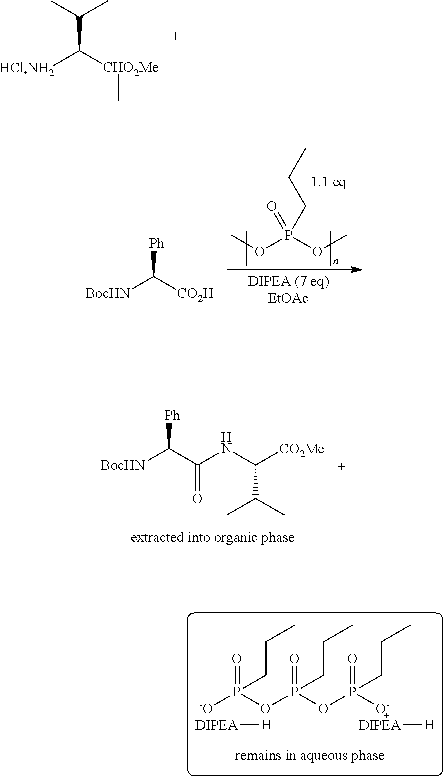

The phosphonic acid components in the waste aqueous phase may then be recovered using the process of the present invention.

The phosphonic acid recovered in the process of the present invention may be converted to a phosphonic acid anhydride (step iii)). The phosphonic acid anhydride may have a structure as defined above. The phosphonic acid anhydride recovered does not have to have the same structure as the phosphonic acid anhydride from which the spent solution is derived. The anhydride regeneration may be done by any of the processes known in the art, for example, those disclosed in U.S. Pat. No. 4,195,035, U.S. Pat. No. 5,319,138, DE 2,758,580 or US 2006/0264654.

Alternatively, the present invention provides a method for converting a phosphonic acid in to a phosphonic acid anhydride wherein SOCl₂ may be used. This method may be applied to a phosphonic acid recovered by the process of the present invention. The molar ratio of SOCl₂ to phosphonic acid is preferably between about 0.9:1 and about 1.1:1, more preferably in a ratio of about 1:1.

The solvent for this reaction may preferably be any organic solvent that forms an azeotrope with water, for example, toluene, chloroform, tetrahydrofuran, methyl-tetrahydrofuran or the alike. The reaction mixture may be heated to a temperature of about 50° C. to about 150° C., preferably about 60° C. to about 100° C., most preferably about 80° C. The reaction mixture may be held at this temperature for a period of about 30 to about 180 minutes, preferably about 60 minutes. HCl and SO₂ are removed and further purification steps, e.g. refluxing and/or nitrogen purges, may be used to further reduce the amounts of HCl and SO₂ present. This produces a mixture of the linear and cyclic forms of the phosphonic acid anhydride in variable proportions depending upon the precise reaction conditions selected. The cyclic phosphonic anhydride may then optionally be distilled under reduced pressure according to known methods (Wissman, 1980).

An embodiment of this process is displayed in the scheme below (the pictographic representations of the two phosphonic acid anhydride structures are only indications of the dominant structure(s) of the phosphonic acid anhydrides produced):

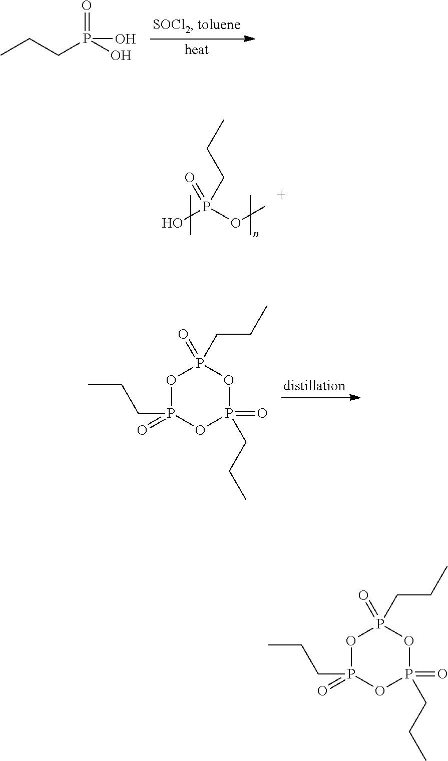

wherein n is an integer between about 1 and about 300, preferably between about 3 and about 100, more preferably between about 3 and about 20.

The yield of the recycled phosphonic acid with regard to the initial aqueous wastes is greater than about 50 wt. %, preferably from about 60 wt. % to about 90 wt. %, for example, about 60 wt. % to about 75 wt. %.

Alternatively, the present invention provides a method for converting a phosphonic acid into a phosphonic acid anhydride wherein acetic anhydride (Ac₂O) may be used. This method may be applied to a phosphonic acid recovered by the process of the present invention. Ac₂O is used in excess and may also perform a drying function such that azeotropic drying of the phosphonic acid anhydride is not required. The molar ratio of Ac₂O to phosphonic acid is preferably between about 1.2:1 and about 20:1, more preferably between about 2:1 and about 10:1, more preferably in a ratio of about 5:1.

The solvent for this reaction may preferably be any organic solvent that does not contain active hydrogens, for example, toluene, chloroform, tetrahydrofuran, methyl-tetrahydrofuran or the like. Alternatively, Ac₂O may perform the function of solvent as well as reagent. The reaction mixture may be heated to a temperature of between about 50° C. to about 150° C., preferably about 100° C. to about 140° C., more preferably between about 120° C. and about 140° C., most preferably about 130° C. The reaction mixture may be held at this temperature for a period of about 1 hour to about 5 days, preferably between about 4 hours and 3 days, more preferably about 12 hours. Preferably, the reaction is carried out under an inert atmosphere, for example nitrogen or argon. At the end of the period, AcOH and Ac₂O are removed by any method known in the art, for example, distillation under reduced pressure, to leave a mixture consisting primarily of the cyclic phosphonic acid anhydride, which may then optionally be distilled under reduced pressure according to known methods (Wissman, 1980).

Although the preparation of phosphonic acid anhydrides using Ac₂O is known in the art (e.g. U.S. Pat. No. 5,319,138), this process produces olgomeric phosphonic acid anhydrides (degree of polymerisation of 20 to 200) which must then be subjected to an additional reactive distillation (see, for example, US 2006/0264654) to afford the more useful cyclic form. The process of the present invention provides a “one step” method that does not require the additional reactive distillation step of the prior art to afford the cyclic phosphonic acid anhydride, i.e. the process of the present invention primarily produces the cyclic phosphonic acid anhydride in “one step” whereas the prior art initially produces the oligomeric phosphonic acid anhydride.

The yield of the recycled phosphonic acid with regard to the initial aqueous wastes is greater than about 50 wt. %, preferably from about 60 wt. % to about 90 wt. %, for example, about 60 wt. % to about 75 wt. %.

### EXAMPLES

The pH was measured at 20° C. using a Jenway 350 portable electronic pH meter with combination pH electrode.

### Reference Example 1

### Peptide Coupling

A suspension of N-BOC-phenylglycine (7.54 g, 30 mmol) and L-valine methylester hydrochloride (5.03 g, 30 mmol) in EtOAc (150 mL) is cooled in an ice bath before addition of N-diisopropylethylamine (26.0 mL, 150 mmol). A solution of propanephosphonic acid anhydride (50 wt % in EtOAc, 20 mL, 33.3 mmol) is then added slowly. The mixture is removed from the cooling bath and allowed to stir overnight at room temperature. Water (200 mL) is added, and the mixture stirred vigorously for 1 h. The two phases are separated, and the aqueous phase washed with MTBE (2×50 mL). The combined organic phases are washed with brine (50 mL) and concentrated to afford the crude peptide. The aqueous phase contains a mixture of propanephosphonic acid oligomers (primarily the linear trimer or salts thereof), along with amine hydrochloride salt and small quantities of amino acid derivatives.

³¹P NMR (242.8 MHz, D₂O): δ (major component) 22.6-22.2 (m), 15.5-15.0 (m).

### Example 1

### Recovery of Propanephosphonic Acid from Aqueous Wastes

An aqueous phase containing the waste products from the peptide coupling of Reference Example 1, using a total of 13 g of propanephosphonic acid anhydride, is treated as follows:

Solid NaOH (16.0 g, 400 mmol) is added, and the resulting biphasic mixture stirred for 1 h. The organic layer (primarily N-diisopropylethylamine) is separated. The aqueous phase is washed with MTBE (2×50 mL) to remove any remaining organic-soluble impurities. ³¹P NMR shows a mixture of propanephosphonic acid derivatives, consisting largely of salts of propanephosphonic acid, its dimer and trimer in variable proportions.

³¹P NMR (242.8 MHz, D₂O): δ 23.5 ppm (s), 22.5 ppm (d, ¹J_{P-P} 31.4 Hz), 19.5 ppm (s), 15.3 ppm (t, ¹J_{P-P} 31.4 Hz).

This is acidified to pH 0 with conc. HCl, and the resulting mixture heated to reflux for a period of 4 h. ³¹P NMR shows only a single signal, corresponding to propanephosphonic acid.

³¹P NMR (242.8 MHz, D₂O): δ 31.1 ppm (s).

The mixture is concentrated and toluene (200 mL) is added; remaining water is removed by toluene azeotrope using a Dean-Stark apparatus. The mixture is hot-filtered to remove NaCl and the filter cake washed with further hot toluene (50 mL). The combined filtrates are concentrated to afford propanephosphonic acid (16.3 g) with around 90% purity (¹H NMR).

### Example 2

### Synthesis of Propanephosphonic Acid Anhydride Using SOCl₂

A solution of crude propanephosphonic acid from Step 2 (16.3 g) in toluene (100 mL) in a round-bottomed flask equipped with condenser is held at 80° C. SOCl₂ (8.6 mL, 118 mmol) is added over a period of 15 min and the mixture is held at this temperature for a further 1 h. Liberated HCl and SO₂ escape via the condenser. The mixture is then heated to reflux for a period of 2 h, with a nitrogen purge during the final 1 h to ensure removal of remaining HCl and SO₂. The mixture is concentrated to afford crude propanephosphonic acid anhydride (15.4 g). Vacuum distillation affords 9.8 g propanephosphonic acid anhydride, equating to a 75 wt. % overall yield in recycling from the initial aqueous wastes.

### Example 3

### Synthesis of Propanephosphonic Acid Anhydride Using Ac₂O

Under a nitrogen atmosphere, a mixture of crude propanephosphonic acid (5 g, 40 mmol) and Ac₂O (20 mL) in a round-bottomed flask equipped with condenser and Dean-Stark adapter was held at 130° C. for 3 days. AcOH and Ac₂O were removed at this temperature under reduced pressure (ca. 20 mbar, then ca. 2 mbar) to afford a brown oil consisting primarily of cyclic propanephosphonic acid anhydride.

³¹P NMR (121.4 MHz, CDCl₃): δ (major component) AB₂ system; δ_{A}=16.88, δ_{B}=14.66 ppm; J_{AB}=²J_{PP}=36.8 Hz. At 242.8 MHz the system approaches AX₂ behaviour.

The identity of the product was further confirmed by addition of a small amount of a solution of T3P® to the NMR solution; subsequent re-analysis disclosed no significant extra signals.

Vacuum distillation then gave purified propanephosphonic anhydride as a colourless oil.

1. A process for the recovery of a phosphonic acid from a solution of a spent phosphonic acid anhydride, comprising the step of:
i) hydrolysis of the solution of the spent phosphonic acid anhydride at a sufficient temperature to form the phosphonic acid.

2. The process of claim 1 wherein the phosphonic acid has the structure: 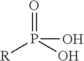
wherein R is an optionally substituted, optionally unsaturated, C₁₋₁₀ linear or branched alkyl group.

3. The process of claim 1 wherein the solution of the spent phosphonic acid anhydride is derived from a phosphonic acid anhydride having at least one of the following structures: 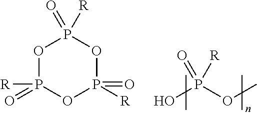
wherein R is independently an optionally substituted, optionally unsaturated C₁₋₁₀ linear or branched alkyl group, and n is an integer between 1 and 300.

4. The process of claim 2 wherein R is a C₁₋₅ linear alkyl group, preferably a propyl group.

5. The process of claim 1 wherein step i) comprises the addition of an acid or a base to the spent solution.

6-11. (canceled)

12. The process of claim 1 further comprising a step ii) of recovering the phosphonic acid.

13. The process of claim 12 wherein step ii) comprises at least one of: at least one concentration step; a water removal step; and a filtration step.

14. The process of claim 1 wherein prior to step i) a salt formation step is carried out (“step a)”).

15. (canceled)

16. The process of claim 14 wherein in step a) an organic phase is produced and said organic phase is extracted (“step b)”).

17. The process of claim 1 wherein prior to step i) or step a), if present, an organic residue extraction (“step 1)”) is carried out.

18. The process of claim 1 wherein the spent solution is aqueous.

19. The process of claim 1 wherein the spent solution comprises a mixture of phosphonic acid oligomers and salts, free acids or alkyl esters thereof.

20. The process of claim 19 wherein the phosphonic acid oligomers are monomers, dimers, trimers, or mixtures thereof.

21. The process of claim 1 wherein the spent solution is a waste aqueous phase of a peptide coupling reaction where a phosphonic acid anhydride is used as a coupling promoter.

22. The process of claim 1 wherein the phosphonic acid recovered is converted to a phosphonic acid anhydride (“step iii)”).

23. The process of claim 22 wherein SOCl₂ is used in the conversion.

24. A process for converting a phosphonic acid into a phosphonic acid anhydride wherein SOCl₂ is used.

25. The process of claim 23 wherein the molar ratio of SOCl₂ to phosphonic acid is between about 0.9:1 and about 1.1:1.

26. (canceled)

27. (canceled)

28. A process for converting a phosphonic acid into a cyclic phosphonic acid anhydride comprising the steps of:
1) combining a phosphonic acid and an excess of acetic anhydride,
2) maintaining the reaction mixture for a sufficient period to obtain a cyclic phosphonic acid anhydride, and
3) recovering the cyclic phosphonic acid anhydride.

29-31. (canceled)

32. The process of claim 28 wherein the acetic anhydride and phosphonic acid are combined in an organic solvent that does not contain active hydrogens.

33-37. (canceled)
